(19) United States
(12) Patent Application Publication
(10) Pub. No.: US 2012/0185900 A1
(43) Pub. Date: Jul. 19, 2012

(54) METHOD AND SYSTEM FOR SELECTIVELY VIEWING BROADCAST CHANNEL IN PARTICULAR PLACE

(75) Inventors: Woo Goo PARK, Daejeon (KR); Dae Sik Kim, Gyeonggi-do (KR); Gyung-chul Shin, Daejeon (KR)

(73) Assignee: ELECTRONICS AND TELECOMMUNICATIONS RESEARCH INSTITUTE, Daejeon (KR)

(21) Appl. No.: 13/428,810

(22) Filed: Mar. 23, 2012

Related U.S. Application Data
(62) Division of application No. 12/146,134, filed on Jun. 25, 2008.

(30) Foreign Application Priority Data
Nov. 5, 2007 (KR) 10-2007-0111996

(51) Int. Cl. G06F 13/00

(52) U.S. Cl. 725/38

(57) ABSTRACT

A method and system for selectively viewing a broadcast channel in a particular place is provided. A method of selectively viewing a broadcast channel in a particular place includes: receiving image information associated with different locations of the particular place from a plurality of imaging devices; receiving sound information associated with the particular place from at least one of the plurality of imaging devices; multi-channelizing the image information and the sound information to generate a frame that includes the image information and the sound information; and transmitting the generated frame to a user terminal.

### CROSS-REFERENCE TO RELATED APPLICATION

This application is a divisional of co-pending application Ser. No. 12/146,134 filed on Jun. 25, 2008, and claims priority from Korean Patent Application No. 10-2007-0111996, filed on Nov. 5, 2007, in the Korean Intellectual Property Office, the entire disclosure of which is incorporated herein by reference.

### BACKGROUND OF THE INVENTION

1. Field of the Invention

The present invention relates to a method and system for selectively viewing a broadcast channel in a particular place. This work was supported by the IT R&D program of MIC/IITA. [2006-S-003-02, Research on service platform for next generation mobile communication]

2. Description of Related Art

Generally, digital broadcasting indicates a broadcasting service that replaces conventional analog broadcasting to provide a user with an enhanced service such as a high definition broadcast and excellent sound quality. Digital broadcasting is classified into digital satellite broadcasting and terrestrial digital broadcasting. Digital satellite broadcasting is generally based on a mobile service and enables the user to view broadcasts of multimedia in multiple channels via a portable receiver, such as a mobile phone and a portable device, or a vehicle-based receiver, regardless of a time and a location.

Terrestrial digital broadcasting coming from Digital Audio Broadcasting (DAB) performs multimedia broadcasting for mobile receiving via a currently unused Very High Frequency (VHF) channel 12. The terrestrial digital broadcasting may multi-cast television (TV) broadcasting, radio broadcasting, and data broadcasting via multiple channels.

Currently, development in digital broadcasting technology and mobile communication technology has heightened users' interest in digital broadcasting services that enable the users to view digital broadcasting while moving. In particular, a Digital Multimedia Broadcasting (DMB) service using a mobile communication terminal is becoming popular.

As digital broadcasting is becoming commercialized, broadcast programs provided by a plurality of providers provides are being diversified. Also, since a broadcasting time zone is diversified, digital broadcast receiving terminal users may select a broadcast program associated with their own concerns from many broadcast programs and view the selected broadcast program.

However, when viewing a game that is being played in a particular place, for example, a football field, using a terminal, the user should view the game via a limited channel such as a ground wave or a sky wave. Specifically, all the users should view the same image at the same time. Accordingly, when the user desires to view a soccer game being played in a soccer field from a different location or angle, current sky wave broadcasting has some constraint.

Accordingly, there is a need for a technology that can provide a user with images taken from different locations of a particular place using a radio system and thereby enables the user to select a desired channel from many channels.

### SUMMARY OF THE INVENTION

An aspect of the present invention provides a method and system for selectively viewing a broadcast channel in a particular place that can multi-channelize images taken from different locations of a particular place, such as a soccer field, using a plurality of imaging devices and then provide multi-channels to a user terminal of a user using a radio system and thereby enables the user to select a channel associated with the user's desired image from the multi-channels and view the selected channel.

Another aspect of the present invention also provides a method and system for selectively viewing a broadcast channel in a particular place that can provide images taken from different locations of a particular place, using a broadcasting service different from a sky wave and thereby can improve user needs.

Another aspect of the present invention also provides a method and system for selectively viewing a broadcast channel in a particular place that can provide an authorization code associated with authorizing usage of a selective broadcast channel viewing service and thereby enables only a user that receives the authorization code to use the service.

The present invention is not limited to the above purposes and other purposes not described herein will be apparent to those of skill in the art from the following description.

According to an aspect of the present invention, there is provided a method of selectively viewing a broadcast channel in a particular place, the method including: receiving image information associated with different locations of the particular place from a plurality of imaging devices; receiving sound information associated with the particular place from at least one of the plurality of imaging devices; multi-channelizing the image information and the sound information to generate a frame that includes the image information and the sound information; and transmitting the generated frame to a user terminal.

The generating of the frame may include: including device information associated with each of the imaging devices in the image information that is received from each of the imaging devices; and multi-channelizing the image information, including the device information, with the sound information to generate a single sequence frame.

According to another aspect of the present invention, there is provided a method of selectively viewing a broadcast channel in a particular place, the method including: receiving a frame from a server; interoperating with a user's selected broadcast channel to extract image information and sound information corresponding to the selected broadcast channel from the received frame; and outputting the extracted image information and the sound information to a user terminal of the user.

The method may further include: generating a still image corresponding to the broadcast channel based on the image information of the frame; and providing the generated still image to the user terminal. Also, the extracting of the image information and the sound information may include: extracting image information and sound information corresponding to the selected broadcast channel from the received frame when the user selects the broadcast channel using the still image.

The method may further include: determining whether to permit the selection on the broadcast channel based on user state information of the user; and assigning to the user an authorization code that permits the selection on the broadcast channel, based on the determination result.

The method may further include: suspending usage of the assigned authorization code after a predetermined period of time.

The outputting may include: playing the image information and the sound information using an imaging device and a sound device that are installed in the user terminal; and reproducing the played image information and the sound information on a display device that is installed in the user terminal.

According to still another aspect of the present invention, there is provided a system for selectively viewing a broadcast channel in a particular place, the system including: a receiver to receive image information associated with different locations of the particular place from a plurality of imaging devices, and to receive sound information associated with the particular place from at least one of the plurality of imaging devices; a frame generator to multi-channelize the image information and the sound information to generate a frame that includes the image information and the sound information; and a transmitter to transmit the generated frame to a user terminal.

The frame generator may include device information associated with each of the imaging devices, in the image information that is received from each of the imaging devices, and multi-channelize the image information, including the device information, with the sound information to generate a single sequence frame.

According to yet another aspect of the present invention, there is provided a system for selectively viewing a broadcast channel in a particular place, the system including: a receiver to receive a frame from a server; an extractor to interoperate with a user's selection on the broadcast channel to extract image information and sound information corresponding to the selected broadcast channel from the received frame; and an output unit to output the extracted image information and the sound information to a user terminal of the user.

The extractor may generate a still image corresponding to the broadcast channel based on the image information of the frame, provide the generated still image to the user terminal, and extract image information and sound information corresponding to the selected broadcast channel from the received frame, when the user selects the broadcast channel using the still image.

The system may further include: a code assignment unit to determine whether to permit the selection on the broadcast channel based on user state information of the user, and to assign to the user an authorization code that permits the selection on the broadcast channel, based on the determination result.

The code assignment unit may suspend usage of the assigned authorization code after a predetermined period of time.

The output unit may transfer the image information and the sound information using an imaging device and a sound device that are installed in the user terminal, and reproduce the played image information and the sound information on a display device that is installed in the user terminal.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates a system for selectively viewing a broadcast channel in a particular place according to an embodiment of the present invention;

FIG. 2 is a block diagram illustrating a system for selectively viewing a broadcast channel in a particular place according to an embodiment of the present invention;

FIG. 3 is a block diagram illustrating a system for selectively viewing a broadcast channel in a particular place according to another embodiment of the present invention;

FIG. 4 is a flowchart illustrating a method of selectively viewing a broadcast channel in a particular place according to an embodiment of the present invention; and

FIG. 5 is a flowchart illustrating a method of selectively viewing a broadcast channel in a particular place according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

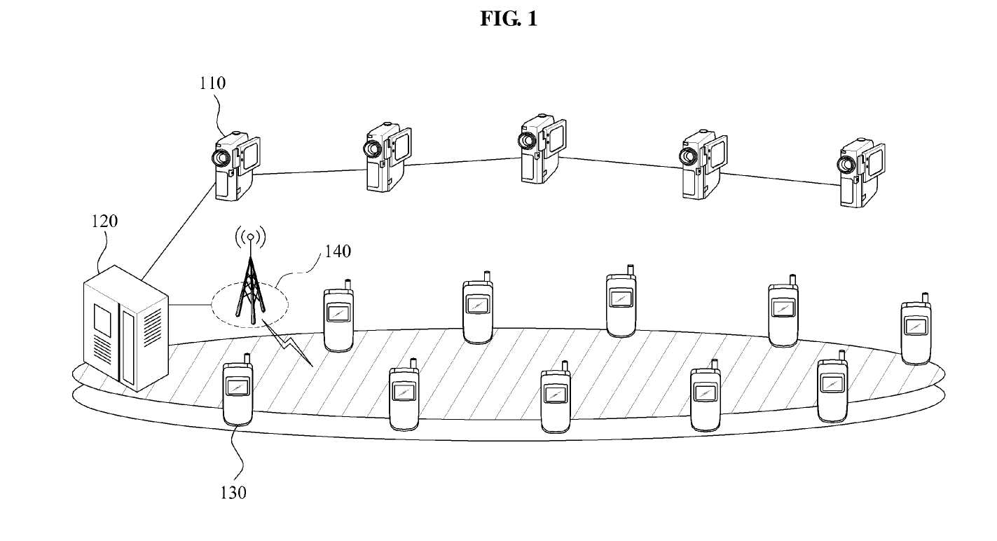

FIG. 1 illustrates a system for selectively viewing a broadcast channel in a particular place according to an embodiment of the present invention.

Referring to FIG. 1, a plurality of imaging devices 110 may be installed in different locations of the particular place, respectively. The plurality of imaging devices 110 may take images associated with a situation occurring in the particular place from various types of angles and locations of the particular place. The plurality of imaging devices 110 may transmit image information to a server 120.

For example, the plurality of imaging devices 110 may be installed in a soccer field, a fashion show, and the like. When the plurality of imaging devices 110 is installed in the soccer field, the imaging devices 110 may be installed in different locations to take images of scenes of a soccer game at different angles and locations, respectively. The plurality of imaging devices 110 may transmit to the server 120 image information that includes the images of scenes taken from various angles and locations.

Also, the plurality of imaging devices 110 may record sound coming from the particular place, store the recorded sound as information, and transmit sound information to the server 120. The sound information may be generated by at least one of the imaging devices 110.

The server 120 may receive the image information from the plurality of imaging devices 110 and may also receive the sound information from at least one of the plurality of imaging devices 110. The server 120 may multi-channelize the received image information and the sound information, and then transmit the multi-channelized information to a user terminal 130 via a radio base station 140.

When the user selects a broadcast channel that includes image information taken from the user's desired direction, the user terminal 130 may receive image information and sound information corresponding to the selected broadcast channel from the server 120. The user terminal 130 may transmit the received image information and the sound information to an imaging device and a sound device. Through this, the user may view the image information and the sound information on a screen.

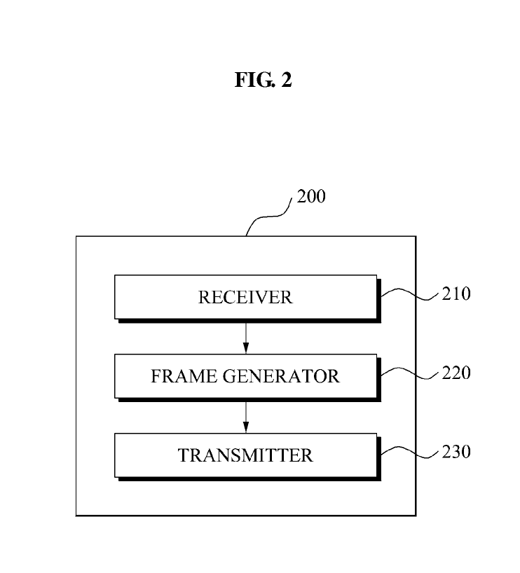

FIG. 2 is a block diagram illustrating a system 200 for selectively viewing a broadcast channel in a particular place according to an embodiment of the present invention. The system 200 may be installed in the server 120 of FIG. 1.

Referring to FIGS. 1 and 2, the system 200 may include a receiver 210, a frame generator 220, and a transmitter 230.

The receiver 210 may receive image information associated with different locations of the particular place from the plurality of imaging devices 110. For example, the receiver 210 may receive image information, such as soccer game scenes, fashion show scenes, and the like, taken from various angles, from the plurality of imaging devices 110 that are installed in the different locations of the particular place such as a soccer game, a fashion show, and the like.

The receiver 210 may receive sound information associated with the particular place from at least one of the plurality of imaging devices 110. Since the sound information may be generated by the at least one imaging device 110, the receiver 210 may receive the sound information from the at least one imaging device 110.

The frame generator 220 may multi-channelize the received image information and the sound information to generate a frame that includes the image information and the sound information.

The frame generator 220 may include device information associated with each of the imaging devices 110, in the image information that is received from each of the imaging devices 110. The frame generator 220 may multi-channelize the image information, including the device information, with the sound information to generate a single sequence frame.

The frame generator 220 may construct the image information and the sound information as a channel appropriate for the radio base station 140 that is installed in a corresponding space, and then produce all the image information and the sound information into the single sequence frame through the multi-channelization.

The frame may include n superframes. Each superframe may consist of a preamble and a header channel. The preamble may be used for identifying the superframe and the header channel may include frame information. For example, a zero^{th} superframe may include sound information (signal) and remaining superframes may include image information (signal).

The frame may be provided for each television (TV) channel. The TV channel may be constructed using the TV channel structure in a wireless broadband (WiBro), T-DMB, and a wireless local area network (WLAN). The TV channel may provide a broadcasting service for particular users in a limited space, using an existing broadcast channel such as a WiBro, ground wave DMB, and wideband code division multiplex access (WCDMA).

The transmitter 230 may transmit the generated frame to the user terminal 130. The transmitter 230 may transmit the generated frame to the user terminal 130 via the radio base station 140.

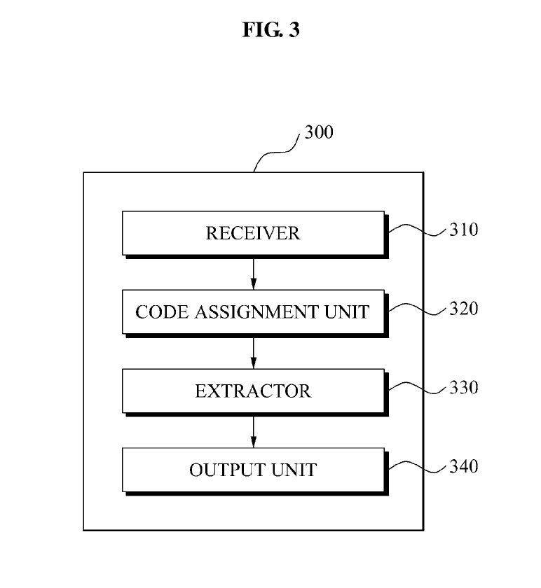

FIG. 3 is a block diagram illustrating a system 300 for selectively viewing a broadcast channel in a particular place according to another embodiment of the present invention. The system 300 may be installed in the user terminal 130 of FIG. 1.

Referring to FIGS. 1 and 3, the system 300 may include a receiver 310, a code assignment unit 320, an extractor 330, and an output unit 340.

The receiver 310 may receive a frame from the server 120. The receiver 310 may receive the frame that includes image information and sound information from the system 200 of FIG. 2 that is installed in the server 120. The frame may be the above-described single sequence frame.

The code assignment unit 320 may determine whether to permit the selection on the broadcast channel based on user state information of the user. The code assignment unit 320 may assign to the user an authorization code that permits the selection on the broadcast channel, based on the determination result.

In order to use a selective broadcast channel viewing service, the user may request permitting usage of the selective broadcast channel viewing service using the Internet or the user terminal 130. According to the usage permitting request, the code assignment unit 320 may verify the user state information of the user through the Internet or the user terminal 130 to thereby determine whether to permit the selection on the broadcast channel. When it is determined the user state information satisfies a permission condition associated with the selection on the broadcast channel, the code assignment unit 320 may assign to the user the authorization code that permits the selection on the broadcast channel.

The usage permitting request may include a temporary request and a constant request. The temporary request is to request a temporary usage permission in the particular place such as a soccer field, a concert, and the like, using the user terminal 130. A system that receives the temporary request via the user terminal 130 may verify the user state information, for example, a credit state, the availability of selective broadcast channel viewing service, restrictions thereof, and the like, and may transmit an authorization code to the user terminal 130.

The constant request is to request a constant usage permission using the Internet. A system that receives the constant request via the Internet may verify the user state information and then transmit an authorization code to the user terminal 130. The code assignment unit 320 may suspend usage of the assigned authorization code after a predetermined period of time. The code assignment unit 320 may activate the authorization code during a predetermined period of time to thereby maintain the selective broadcast channel viewing service. When the period of time is elapsed, the code assignment unit 320 may suspend the authorization code to thereby terminate the selective broadcast channel viewing service. The period of time may be set by a second unit.

The extractor 330 may interoperate with the user's selection on the broadcast channel to extract image information and sound information corresponding to the selected broadcast channel from the received frame. For example, when the user selects an n^{th} channel, the extractor 330 may extract image information and sound information corresponding to the n^{th} channel from the received frame.

The extractor 330 may generate a still image corresponding to the broadcast channel based on the image information of the frame and provide the generated still image to the user terminal 130. Specifically, the extractor 330 may generate the still image based on the image information and make a broadcast channel correspond to the still image. Also, the extractor 330 may provide the still image corresponding to the broadcast channel to the user terminal 130.

When the user selects the broadcast channel using the still image, the extractor 330 may extract image information and sound information corresponding to the selected broadcast channel from the received frame.

The output unit 340 may output the extracted image information and the sound information to the user terminal 130 of the user. The output unit 340 may transfer the image information and the sound information to an imaging device and a sound device that are installed in the user terminal, and reproduce the image information and the sound information on a display device that is installed in the user terminal 130.

The user terminal 130 may transfer the image information and the sound information to each imaging device and sound device and play the image information and the sound information via the imaging device and the sound device. The user terminal 130 may reproduce the image information and the sound information on the display device. Accordingly, the user may view an image and sound in the user's desired location of the particular place.

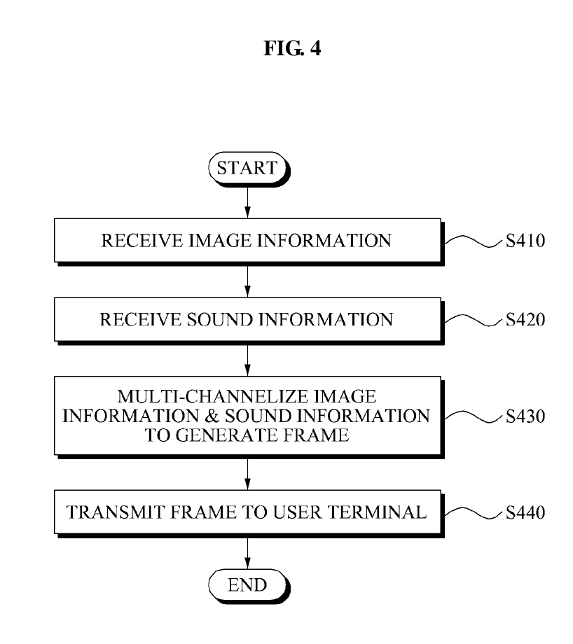

FIG. 4 is a flowchart illustrating a method of selectively viewing a broadcast channel in a particular place according to an embodiment of the present invention. The method may be performed by a system for selectively viewing a broadcast channel that is installed in the server 120 of FIG. 1.

Referring to FIGS. 1 and 4, in operation S410, the system may receive image information associated with different locations of the particular place from the plurality of imaging devices 110. Specifically, the system for selectively viewing the broadcast channel may receive image information, such as soccer game scenes, fashion show scenes, and the like, taken from various angles, from the plurality of imaging devices 110 that are installed in the different locations of the particular place such as a soccer game, a fashion show, and the like.

In operation S420, the system may receive sound information associated with the particular place from at least one of the plurality of imaging devices 110. Since the sound information may be generated by the at least one imaging device 110, the system may receive the sound information from the at least one imaging device 110.

In operation S430, the system may multi-channelize the received image information and the sound information to generate a frame that includes the image information and the sound information.

Specifically, the system may include device information associated with each of the imaging devices 110, in the image information that is received from each of the imaging devices 110. The system may multi-channelize the image information, including the device information, with the sound information to generate a single sequence frame.

The system may construct the image information and the sound information as a channel appropriate for the radio base station 140 that is installed in a corresponding space, and then produce all the image information and the sound information into the single sequence frame through the multi-channelization.

In operation S440, the system may transmit the generated frame to the user terminal 130. The system may transmit the generated frame to the user terminal 130 via the radio base station 140.

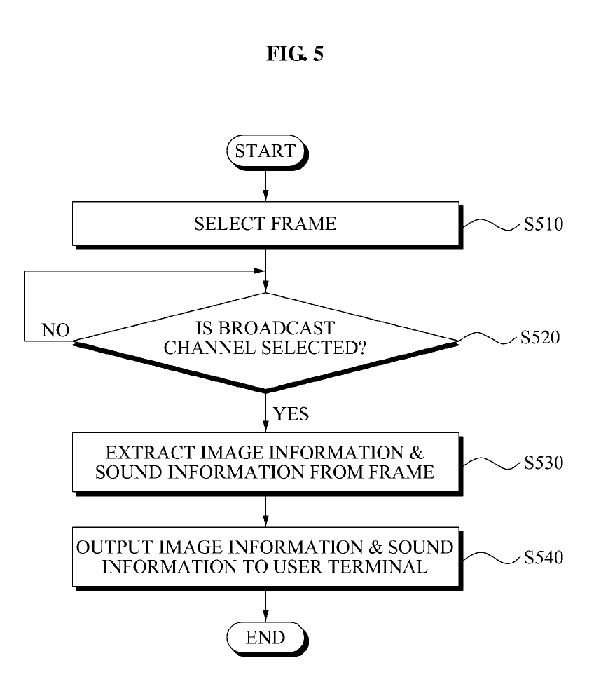

FIG. 5 is a flowchart illustrating a method of selectively viewing a broadcast channel in a particular place according to an embodiment of the present invention. The method may be performed by a system for selectively viewing a broadcast channel that is installed in the user terminal 130 of FIG. 130.

Referring to FIGS. 1 and 5, in operation S510, the system for selectively viewing the broadcast channel may receive a frame from the server 120. The system may receive the frame that includes image information and sound information from the system 200 of FIG. 2 that is installed in the server 120. The frame may be the above-described single sequence frame.

In operation S520, the system may determine whether to permit the selection on the broadcast channel. When it is determined the broadcast channel is not selected by the user, that is, in the case of no direction in operation S520, the system may maintain a waiting state for waiting for the user's selection on the broadcast channel.

Conversely, when the broadcast channel is selected by the user, that is, in the case of yes direction in operation S520, the system may perform operation S530.

In operation S530, the system may extract image information and sound information corresponding to the selected broadcast channel from the received frame. For example, when the user selects an n^{th} channel, the system may extract image information and sound information corresponding to the n^{th} channel from the received frame.

The system may generate a still image corresponding to the broadcast channel based on the image information of the frame and provide the generated still image to the user terminal 130. Specifically, the system may generate the still image based on the image information and make a broadcast channel correspond to the still image. Also, the system may provide the still image corresponding to the broadcast channel to the user terminal 130.

When the user selects the broadcast channel using the still image, the system may extract image information and sound information corresponding to the selected broadcast channel from the received frame.

In operation S540, the system may output the extracted image information and the sound information to the user terminal 130 of the user. The system may transfer the image information and the sound information to an imaging device and a sound device that are installed in the user terminal, and reproduce the played image information and the sound information on a display device that is installed in the user terminal.

The user terminal 130 may transfer the image information and the sound information to each imaging device and sound device and play the image information and the sound information via the imaging device and the sound device. The user terminal 130 may reproduce the image information and the sound information on the display device. Accordingly, the user may view an image and sound in the user's desired location of the particular place.

The system may determine whether to permit the selection on the broadcast channel based on user state information of the user. The system may assign to the user an authorization code that permits the selection on the broadcast channel, based on the determination result. Also, the system may enable a selective broadcast channel viewing service only in the user terminal 130 that is assigned with the authorization code.

In order to use the selective broadcast channel viewing service, the user may request permitting usage of the selective broadcast channel viewing service using the Internet or the user terminal 130. According to the usage permitting request, the system may verify the user state information of the user through the Internet or the user terminal 130 to thereby determine whether to permit the selection on the broadcast channel. When it is determined the user state information satisfies a permission condition associated with the selection on the broadcast channel, the system may assign to the user the authorization code that permits the selection on the broadcast channel.

The usage permitting request may include a temporary request and a constant request. The temporary request is to request a temporary usage permission in the particular place such as a soccer field, a concert, and the like, using the user terminal 130. A system that receives the temporary request via the user terminal 130 may verify the user state information, for example, a credit state, the availability of selective broadcast channel viewing service, restrictions thereof, and the like, and may transmit an authorization code to the user terminal 130.

The constant request is to request a constant usage permission using the Internet. A system that receives the constant request via the Internet may verify the user state information and then transmit an authorization code to the user terminal 130.

The system may suspend usage of the assigned authorization code after a predetermined period of time. The system may activate the authorization code during a predetermined period of time to thereby maintain the selective broadcast channel viewing service. When the period of time is elapsed, the system may suspend the authorization code to thereby terminate the selective broadcast channel viewing service. The period of time may be set by a second unit.

The selective broadcast channel viewing method according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there may be provided a method and system for selectively viewing a broadcast channel in a particular place that can multi-channelize images taken from different locations of a particular place, such as a soccer field, using a plurality of imaging devices and then provide multi-channels to a user terminal of a user using a radio system and thereby enables the user to select a channel associated with the user's desired image from the multi-channels and view the selected channel.

Also, according to the present invention, there may be provided a method and system for selectively viewing a broadcast channel in a particular place that can provide images taken from different locations of a particular place, using a broadcasting service different from a sky wave and thereby can improve user needs.

Also, according to the present invention, there may be provided a method and system for selectively viewing a broadcast channel in a particular place that can provide an authorization code associated with authorizing usage of a selective broadcast channel viewing service and thereby enables only a user that receives the authorization code to use the service.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of selectively viewing a broadcast channel in a particular place, the method comprising:
receiving a frame from a server;
generating a still image using image information of the received frame;
providing the generated still image to a user terminal of a user;
extracting from the received frame the image information and sound information corresponding to a broadcast channel selected by the user via the still image; and
outputting the extracted image and sound information to the user terminal.

2. The method of claim 1, further comprising:
determining whether to permit the selection on the broadcast channel based on user state information of the user; and
assigning to the user an authorization code that permits the selection on the broadcast channel, based on a result of the determination.

3. The method of claim 2, further comprising:
suspending usage of the assigned authorization code after a predetermined period of time.

4. The method of claim 1, wherein the outputting comprises:
playing the image information and the sound information using an imaging device and a sound device that are installed in the user terminal; and
reproducing the played image information and the sound information on a display device that is installed in the user terminal.

5. A system for selectively viewing a broadcast channel in a particular place, the system comprising:
a receiver receiving a frame from a server;
an extractor generating a still image using image information of the received frame, providing the generated still image to a user terminal of a user, and extracting from the received frame the image information and sound information corresponding to a broadcast channel selected by the user via the still image; and
an output unit outputting the extracted image and sound information to the user terminal.

6. The system of claim 5, further comprising:
a code assignment unit to determine whether to permit the selection on the broadcast channel based on user state information of the user, and to assign to the user an authorization code that permits the selection on the broadcast channel, based on a result of the determination.

7. The system of claim 6, wherein the code assignment unit suspends usage of the assigned authorization code after a predetermined period of time.

8. The system of claim 5, wherein the output unit transfers the image information and the sound information using an imaging device and a sound device that are installed in the user terminal, and reproduces the played image information and the sound information on a display device that is installed in the user terminal.
